(19) United States
(12) Patent Application Publication
(10) Pub. No.: US 2011/0206488 A1
(43) Pub. Date: Aug. 25, 2011

(54) Portable mechanical lifting and lowering device

(76) Inventors: Michael E. Windsor, Weir, KS (US); Morgan T.M. Windsor, Weir, KS (US)

(21) Appl. No.: 12/660,250

(22) Filed: Feb. 24, 2010

(51) Int. Cl. B66D 3/00; B66F 19/00; B66F 3/00; B66D 3/18; B66F 3/24; B66C 23/00

(52) U.S. Cl. 414/462; 254/1; 254/266; 254/93 VA; 254/30; 212/232; 254/362; 254/361; 254/2 R

(57) ABSTRACT

A portable mechanical lifting and lowering device for mounting in or on a host vehicle with various lifting and lowering configurations that enable the user to lift, lower, move and operate items, equipment and farm style implements using hydraulic, electrical, or other mechanical means of power, including but not limited to a lifting mechanism that mimic's the lifting ability of a farm tractor style three point hitch configuration by attaching to the trailer hitch receiver port of a host vehicle and being operated with an implement attached; and a mechanism that can lift or lower items into the earth, or other surface, in a straight or twisting fashion; and a trailer hitch attachment for a trailer hitch ball that can be easily lifted and lowered; and a crane style mechanism that can lift, lower or move items, all incorporated in this one device. The portable mechanical lifting and lowering device can be used in a stationary position or used in portable modes for use with host vehicles, trailers, and other modes of transportation. The device can be used with or without additional support mechanisms such as static or adjustable wheels, stands, jacks, runners, skids, or other means of additional support. The portable mechanical lifting and lowering device can be used with a single trailer hitch style attachment or multiples thereof, on the front or rear of a host vehicle and can also be adapted for a trailer hitch ball style attachment and can be pulled as a trailer.

### CROSS REFERENCE TO RELATED APPLICATION

This application references provisional application No. 60/941,866, filed Jun. 4, 2007, which incorporates a portable power and utility system that can be mounted in the host vehicle and thus supply the necessary power; electrical (AC or DC), air pressure, or hydraulic oil pressure required to operate this invention of the portable mechanical lifting and lowering device. The invention of the portable power and utility system referenced, can be used in a standard pickup truck, ATV, trailer or other type vehicle, and now enables the user to provide the necessary power for the power of motion devices on the portable mechanical lifting and lowering device, for easily operating this new invention when attached to the host vehicle. Read more about the referenced portable power and utility system at: http://www.faqs.org/patents/app/20080297103#ixzz0eEMrTMiT

### BACKGROUND OF THE INVENTION

1. Field of the Invention

The present invention relates generally to a specialized portable mechanical lifting and lowering device, in particular to a compact, portable mechanical lifting system for providing a broad range of lifting or lowering capabilities and functions in various environments, which can be used to lift and lower and operate most farm style three point hitch implements and tools, lifting and lowering items in a crane type fashion and lifting (extracting) and lowering (inserting) items into the earth or subsurface of material with a straight or twisting/turning fashion, in multiple planes, with other various configurations to allow the unit to perform multiple task, from a stationary position, or from a mounting to a host vehicle, most notably to the trailer hitch receiver port of the vehicle for ease of use and operation. There is a menagerie of tools and implements that use the standard three point hitch type attachment, all of which can be adapted and used by the portable mechanical lifting and lowering device to perform work task and functions as required by the user.

2. Description of the Related Art

Various types of mechanical lifting and lowering devices are used to lift and move, and operate items and to perform work operations. Farm style tractors have incorporated the use of the three point hitch style lifting mechanism for many years, due to their controllable on board hydraulic systems, that provides the power of motion for the lifting mechanism and movement of the lifting arms. This new invention, the portable mechanical lifting and lowering device, as example, now enables the user to quickly and easily attach it to their vehicle's trailer hitch receiver port and then hook up the electrical, air or hydraulic power source to the power of motion mechanism on the portable mechanical lifting and lowering device, and under user controlled mechanism(s), enabling the user to operate the mechanical lifting arms of the device to lift and lower various items, including but not limited to, virtually any three point hitch style implement and therefore allowing the user to control the portable mechanical lifting and lowering device, by mechanical, wired or wireless control, from the interior or exterior of the vehicle, including the drivers cab. With the use of the previously referenced invention, the portable power and utility system (ref Ser. No. 12/132,861), a user who has one of these system installed in their vehicle, can easily operate this portable mechanical lifting and lowering device using its electrical, pneumatic air, or hydraulic power resources to power the components that supply the power of motion to the device. The user can then use a scraper blade, landscape rake, platform, fork lift style forks, bale spike and other items, attached to the vehicle instead of having to use a farm style tractor with a similar style three point hitch mechanism and its hydraulic power supply, which has always been required in the past.

Work example; A user, using their standard vehicle, can take a standard three point hitch style scraper blade implement, and can now scrape their driveway, remove snow, landscape or smooth surfaces. The user can use fork lift style forks to move or stack pallets using their vehicle. A user could use a platform and lift it to or above the height of the vehicle bed to more easily load items into the vehicle. All, without the need for a farm style tractor with similar capability.

One of the best adaptations is to enable the pickup truck to pick up a three point hitch style log splitter, carry it to the trees to gather and split wood. A portable power and utility system could power the hydraulics to lift and operate the portable mechanical lifting and lowering device and to operate the hydraulic log splitter. The portable mechanical lifting and lowering device can be attached to the vehicle and the three point hitch log splitter can then be attached to the portable mechanical lifting and lowering device and with power of motion supplied, the log splitter can then be lifted off of the ground so that it can be carried to the work site location of gathering the wood. The portable mechanical lifting and lowering device can then lower the log splitter to the ground for operation and the wood can then be split and loaded into the vehicle in the field, and when finished, the portable mechanical lifting and lowering device can be operated to lift and carry the log splitter back to the residence. This entire task can be accomplished by using one vehicle for the operation, as compared to the current circumstance of having to take a farm style tractor to the field to carry and operate the hydraulic log splitter, and also taking a pickup truck or other type vehicle to carry the wood.

The present invention allows the user to attach it at the rear or front of the vehicle being used. The invention can also be used with trailers, ATV's and any other vehicle which can accommodate a trailer hitch style receiver for attachment or by other means of attachment. The portable mechanical lifting and lowering device is also adapted for the use of a trailer hitch ball, that can be attached to the mechanical lifting and lowering device, enabling the user to easily hook up to the trailer hitch attachment on the front of trailers and allowing the user to easily lift the tongue of the trailer and move trailers carrying boats, recreational style trailer vehicles, and any other type of trailer or device that has this kind of trailer hitch ball attachment.

The present invention can also be adapted for trailer hitch ball attachment, so that the device can attach to the vehicle's trailer hitch ball and not be inserted into the trailer hitch receiver port as previously described. In this configuration wheels, runners, or skids are used in a manner to allow for proper movement of the device. The invention can also extend its attachment arm to the trailer hitch receiver ball to allow for a longer distance behind the vehicle as necessary to allow for a trailer style movement of the mechanical lifting and lowering device as it is being towed by the vehicle.

The present invention can utilize the crane portion of the portable mechanical lifting and lowering device to lift and move items as the user requires. The crane portion can be mounted directly to the portable mechanical lifting and lowering device or can be mounted through an adapter directly to the trailer hitch receiver(s) of the host vehicle. The crane portion can also be operated unsupported or supported, as needed, by the addition of adjustable wheel(s), stands, runners, skids, jack stands, or support brackets, depending on the weight of the load to be lifted and the capacity of the vehicle trailer hitch receiver port.

The present invention can be adapted to insert an item into the ground in a straight vertical, horizontal, or angled mode, in two or more angular planes. This function is necessary for properly inserting a fence post, street sign, or mile marker into the ground in a manner that allows the item being inserted to be located in a straight vertical type position, relative to the angle slope of the terrain, which may be at quite a different angle. The device can also extract or remove items. As example, the present invention can be adapted to insert a fence post into the ground, or remove one, by means of a hydraulic cylinder power configured through a mechanism to grasp the steel fence post and insert or remove it from the ground. The fixed attachment of the mechanical lifting device to the vehicle, only adds to the ability of the device to insert the post into the ground, due to the levered weight of the vehicle involved. The reverse of this function is also available and allows the user to easily remove the post from the ground.

The present invention can be adapted to twist or turn the item during the insertion cycle, thus enabling the user to install an earth anchor, concrete type anchor, or other subsurface type anchor with a threaded tip configuration. This ability allows the user to install earth tie down rods for mobile homes, telephone poles, or electric poles. The reverse of this function is also available and allows the user to remove or extract the item from the ground. The invention can be adapted to apply force of motion during the twist or turning operation, where by the rod being moved can be turned in clockwise or counter clockwise direction, while under force of pressure in the desired direction of movement

The present invention which includes the use of single or multiple trailer hitch receivers, can allow for a portable mechanical lifting and lowering device to be attached to one vehicle hitch receiver port and the optional crane portion with adapter to be attached to one of the other vehicle trailer hitch receiver ports so that both systems can be operated at the same time.

The present invention addresses all of these considerations. Heretofore there has not been available a portable mechanical lifting and lowering device such as this, that allows for the adaptation of lifting and lowering items utilizing a three point hitch attachment configurations or other adaptation such as a trailer ball hitch, and other devices and attachments, while attached to the trailer hitch receiver port, or other attachment configuration in the rear or the front of the vehicle, or at a stationary mount or with the aspect of multiple trailer hitch receivers mounted on the vehicle and attaching thereto, or with the ability to lift or lower items into the earth or subsurface using a forced or non force pressure action or a turning or non turning action of extraction and insertion, or through crane style operation of movement, with all aspect of the device being unsupported or supported, with an additional support mechanisms that can be movable or static in their operation, or while being operated into position as load is applied, or have the ability for movement or transport with or without a load in this type of configuration with the advantages and features of the present invention.

### SUMMARY OF THE INVENTION

In the practice of an aspect of the present invention, a portable mechanical lifting and lowering device can be installed in or on a vehicle for portability, to be used with or without additional support and with or without a load, rolled on its own wheels, pulled as in a trailer mode or used with jack stand style supports to provide additional support for lifting and lowering and operating items, equipment, tools, and implements with ease by the operator. Without limitation on the generality of useful applications and resources of the present invention, they can include lifting and lowering, inserting or extracting, of various items. The power of motion can come from mechanical, electrical, pneumatic, or hydraulic type power that operates the portable mechanical lifting and lowering device, which in turn lifts or lowers the item or tool being used. The power supplied can be introduced separately from another source, or can be mounted on board the mechanical lifting and lowering device. On board engines, hydraulic pumps, air pumps, compressed air tanks, on board batteries, AC generators and other means of power can be adapted to power the unit in a self contained operating mode. With proper supports, the system is capable of operating in a complete standalone mode, however the portable mechanical lifting and lowering device is most suited to be used with a host vehicle which is its normal operating mode. With its three point hitch style lifting arms, the portable mechanical lifting and lowering device can be attached to virtually any three point hitch style farm implement or tool and with proper power supplied, can be operated from the vehicle. As example, a standard type three point hitch style scraper blade can be attached to the mechanical lifting and lowering device, allowing the user to scrap his driveway for the leveling or removing of snow by means of their pickup truck style vehicle, instead of having to use a farm style tractor with similar attachment capability. This invention now allows the user to use their own standard vehicle with most standard farm type implements that have a three point hitch style attachment method without requiring a tractor. Until now, this type of device has not been available.

A trailer hitch ball can be attached to the portable mechanical lifting and lowering device therefore allowing the user to easily lift and lower and move (pull or push) the tongues of trailers with a trailer hitch ball receiver attachment. This capability would be very useful at recreational vehicle type dealerships for moving trailer type RV's around the lot, or at a flat bed or livestock trailer dealership, marina or marine dealership, for moving boats on trailers for storage, or for sale on a sale's lot, including the manufacturing facilities building the units described. A three point hitch style bale spike could be attached, allowing the user to spear a bale of hay, lift the bale and transport it to another location to feed animals. Using the portable mechanical lifting and lowering device attached to the trailer hitch receiver port on the vehicle, the size of the bale (weight of the item) is limited by the maximum load of the trailer hitch receiver port. With multiple trailer hitch receiver ports, the portable mechanical lifting and lowering device would be capable of lifting to the sum of the total load of all the trailer hitch receiver ports being used without any additional support needed. As example, if a single trailer hitch receiver port is used, and the load to be lifted exceeds the maximum load of the vehicle's trailer hitch receiver port, then additional support for the portable mechanical lifting and lowering device will be required. The portable mechanical lifting and lowering device is adapted for adding support wheels, adjustable stands, jacks, or other types of support. Of course, any stationary type support would have to be used in a stationary position. Only support wheels, skids or runners, will allow for movement of the vehicle, along with the portable mechanical lifting and lowering device and its load. The support wheel, or wheels of the portable mechanical lifting and lowering device can be adapted to be used in a static position, allowing the load lifting mechanism to operate independently. The support wheels can be attached to the movement of the lifting mechanism to allow the adjustable support wheels to be moved into position as the load of the portable mechanical lifting and lowering device is applied. This enables the unit to be moved easily with no load and no support wheels touching the ground surface and then when load is supplied to the mechanical lifting and lowering device, the wheels are moved into position, either automatically through the actuation of the unit or by hand, prior to the load being applied, allowing the user to now drive the vehicle while lifting the load and while not exceeding the maximum lifting capacity of the vehicle's trailer hitch receiver port. The portable mechanical lifting and lowering device can be adapted and mounted to the front of a vehicle, enabling the user to perform the same type of lifting and lowering work, as was done at the rear of the vehicle. In a snow blade configuration, the user can take their standard type scraper blade, normally used with their farm style tractor and turn it into a snow blade at the front of the vehicle. The vehicle will require a trailer hitch receiver port at the front of the vehicle or the portable mechanical lifting and lowering device will have to be directly attached. Current snow blades are specialized systems and require very special attachments and control systems and special blade configurations and lifting mechanism to function. This portable mechanical lifting and lowering device provides the user the ability to take their existing equipment, (i.e. ˜pickup truck and three point hitch implements(scraper blade)) and perform some of the same tasks as they previously would have, only with a farm type tractor with similar capabilities or a specially configured vehicle.

The crane portion of the portable mechanical lifting and lowering device is adapted to attach directly to the portable mechanical lifting and lowering device, or it can be attached directly to the vehicle trailer hitch port and can use the same cable winch system or power hydraulic or pneumatic cylinder system used to power the portable mechanical lifting and lowering device to operate the crane functions. It can also have its own power lifting system, attached to it individually and operated separately from the portable mechanical lifting and lowering devices three point hitch lifting type mechanism. This can be done with multiple power systems, or the same power system for all functions, with selector switches, or separate valve control modules.

The crane in the direct trailer hitch port attachment mode can only lift items of weight not exceeding the maximum weight capacity of the trailer hitch receiver port of the vehicle. To increase the load capacity of the crane, the crane's main support mast can be adapted to include additional means of support by the way of adjustable stands, drop stands, jacks, or a wheeled mechanism to allow movement, as needed by the vehicle, while lifting the load. Various sizes of cranes and supports can be supplied to accommodate any load.

The ability of the portable mechanical lifting and lowering device to be able to insert items into the earth or other surface, or remove items from the earth or other surface, from a normal type vehicle,e like a pickup truck, is unique and will serve well for multitudes of applications, some of them being for farmers installing fence post, road workers installing mile markers or street signs, electrical or telephone workers installing poles and installing earth anchors to hold them in place against a load, and earth anchors for mobile homes, recreational vehicles or even aircraft owners, who need to “tie down” their property, that can now be easily installed vertically or at a three dimensional angle by the mechanical lifting and lowering device.

### BRIEF DESCRIPTION OF THE DRAWINGS

FIG. 1 is a perspective view of the portable mechanical lifting and lowering device embodying a first aspect of the present invention, showing the general locations of major components and subsystems. The main structure of the portable mechanical lifting and lowering device (01),(02),(03), is shown in the center, showing the lifting devices mechanical design. The unit is shown with a hydraulic cylinder (14), (19), mounted below the main attachment structure arm (01), which in this case the hydraulic cylinder (14), (19) would supply the power to the lifting device (06),(08),(13) and a cable winch (16) is shown center mounted showing the possible cable (17) actuation of the device. Shown to the left of the drawing is the trailer hitch receiver attachment (01),(15), which would commonly be connected to a vehicle trailer hitch port and shown to the right is the three point hitch lifting arms (09),(10),(11), used to lift and operate three point hitch type implements.

FIG. 2 is a perspective view of the system showing the addition of support wheels (20), axle (21), and adjustable pivot support arm (22) attached to the rotating action bar (06) that is moved with the movement function of the hydraulic cylinder (14),(19), rotating the mechanical lifting mechanism (08), attached to adjustable lift pivot point mechanism (13) or cable winch (16), and cable (17), at attachment point (25), therefore operating the device. It also shows trailer ball hitch attachment (23), with a trailer hitch ball (24) on mechanical lifting mechanism (08).

FIG. 3 is one perspective view of the anti-sway mechanism (26), which would be attached to both ends of the main cross structure (02) at attachment point (05) and then connected to lifting arms (09),(10). Drawing is shown as a simple chain for the anti-sway mechanism (26), however, other means of adjustment and attachment can be used, including bolted, welded, screwed, and pinned attachment with chain links and treaded or pinned adjustment mechanisms that can be easily adjusted by the user.

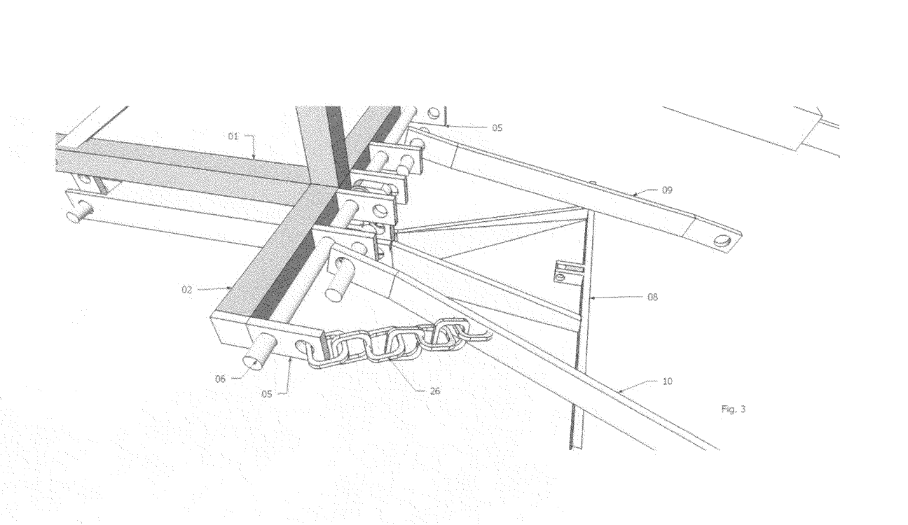

FIG. 4 is a perspective view of the portable mechanical lifting and lowering device (01),(02),(03), with one proposed style of jack (drop) stands (28),(27),(12). This view depicts jack (drop) stands (28),(27), on both ends of the mechanical lifting device cross member (02) for balanced support. The jack (drop) stand (28),(27), could also be inserted in the center of vertical structural support (03) and directly support the center of the device. The jack (drop) stand (28) base plate (27) attachment can be used as shown or can be removed at attachment/locating pin (12) and replaced with other attachments such as wheels, skids, runners or other means of support.

FIG. 5 is a perspective view of the crane lifting and lowering mechanism (29),(30),(31) of the device located in vertical structural support (03) on swivel (29), with main crane mast (30) on swivel (29), with lifting beam (31) attached at top of crane mast (30) with pin (12). Drawing shows attachment point (05) for hydraulic cylinder (14),(19), for lifting and lowering of lifting crane beam (31). Alternate means of lifting and lowering crane beam (31), is shown by means of cable winch (16), with cable (17) shown attached to pin (12). If used with hydraulic cylinder (14), cable winch (16) and cable (17) can be run over pulley (18) at top of crane mast (30) pivot point, with cable running to opposite end of crane beam (31), to another pulley (18) that allows cable (17) to provide vertical up and down movement of hook (32).

FIG. 6 is a perspective view of the crane mast (30) and swivel (29) attachment points and a single style crane adapter (33) and multiple armed crane adapter (34). Swivel (29) and crane mast (30) can be mounted directly to host vehicle single or multiple trailer hitch receiver ports. Crane adapters (33),(34) can be adapted to allow for a jack (drop) stand (28),(27) to be inserted from the bottom and provide additional support for crane mast (30) and crane beam (31).

FIG. 7 is two perspective views of the basic portable mechanical lifting and lowering device (01),(02),(03), depicting attachment to ganged receiver port attachment adapter (35), and multiple attachment arms (36) version for connection to a host vehicle's multiple port trailer hitch receiver or to a stationary application, with or without the use of adapters.

FIG. 8 is a perspective view of the portable mechanical lifting and lowering device (01),(02),(03) with attachment of an extraction and insertion base mechanism (38),(37),(14),(19),(43), that enables the user to insert or extract a steel post (39) or other such items, into the earth or other surface. Angle adjustment mechanism (37) can be swiveled and locked in place with pin (12). Hydraulic cylinder (14) activates and moves action end of cylinder (19), forcing the lever action of the gripping mechanism (43) against the steel post (39) and then against the extraction and insertion base mechanism (38), forcing the steel post (39) to move.

FIG. 9 is a perspective view of the portable mechanical lifting and lowering device (01), with attachment of an extraction and insertion base mechanism (38),(37), shown in a angled position through the position of the angle adjustment mechanism (37), with a hydraulic, electric, or mechanical turning mechanism (41),(42), mounted on the extraction and insertion base mechanism (38), which enables the mechanical turning mechanism (41),(42), to slide up or down on the extraction and insertion base mechanism (38), and when connected to earth tie down rod (40) by means of pin (12), the earth tie down rod (40) can be inserted or extracted from the earth at various angles. Adaption of the mechanical turning mechanism (41) can be attached to a hydraulic cylinder (14),(19) to apply force, for the addition of powered insertion or extraction by the device.

FIG. 10 is a perspective view of the portable mechanical lifting and lowering device (01), with attachment of an extraction and insertion base mechanism (38),(37),(14), shown in a angled position through the position of the angle adjustment mechanism (37) in one plane, and mounted on the rotary adjustment disk (44) apparatus, that allows for movement of the device in a secondary plane, with a hydraulic, electric, or mechanical turning mechanism (41),(42), mounted on the extraction and insertion base mechanism (38). The rotary adjustment disk (44) apparatus consist of two disk affixed at the center on a rotary type pin that enables the disk to be turned on itself, therefore adjusting the angle of the affixed extraction and insertion base mechanism (38). The rotary adjustment disk (44) is positioned to the proper user adjustment point and then affixed in position with pin(s) (12).

### DETAILED DESCRIPTION OF THE PREFERRED EMBODIMENTS

### I. Introduction and Environment

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Certain terminology will be used in the following description for convenience in reference only and will not be limiting. For example, up, down, front, back, right and left refer to the invention as oriented in the view being referred to. The words “inwardly” and “outwardly” refer to directions toward and away from, respectively, the geometric center of the embodiment being described and designated parts thereof. Forwardly and rearwardly are generally in reference to the vehicle on which the system is mounted, if appropriate. Lifting, lowering, inserting and extracting refer to the inventions capabilities in its function. Said terminology will include the words specifically mentioned, derivatives thereof and words of similar meaning.

Referring to the drawings in more detail, the reference numeral (01) generally designates a portable mechanical lifting and lowering device embodying an aspect of the present invention. Without limitation on the useful applications of the device (01), an exemplary aspect is disclosed in or on a host vehicle, e.g. a pickup truck, trailer, SUV, ATV, or any vehicle that may have a trailer hitch style receiver port. A wide variety of alternative installations are within the scope of the present invention, including alternative orientations, mechanisms, and vehicle or stationary attachments. As will be described in more detail below, an aspect of the present invention can be utilized standalone, i.e. remote from a vehicle.

### II. Portable Mechanical Lifting and Lowering Device 01, 02, 03

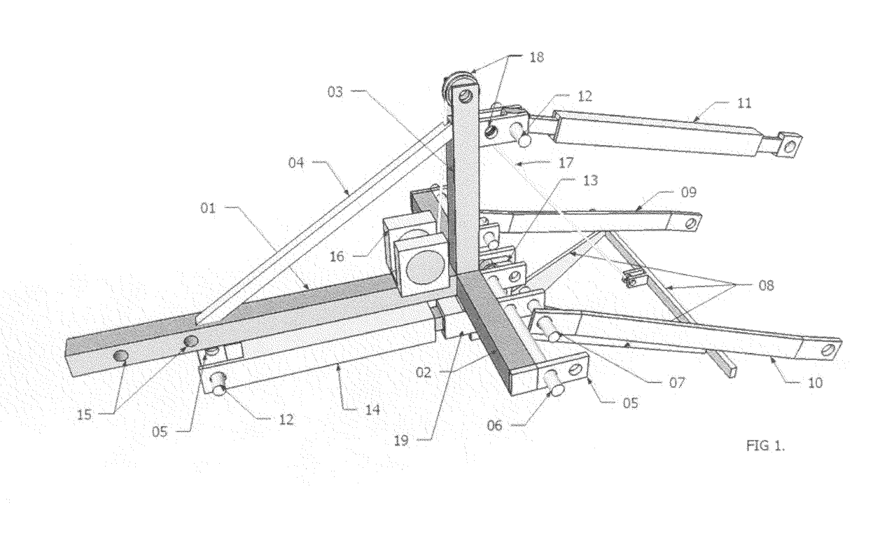

FIG. 1 depicts the general view of the basic unit that shows on the left a standard type trailer hitch style attachment (01), pin attachment point (15), that is designed to mate with a standard vehicle trailer hitch receiver port. The center of the drawing shows a powered motion rotary action rod that supplies a lever action that lifts and lowers a mechanism that in turn lifts and lowers mechanical lifting arms that mimic the three point hitch action of a standard type farm tractor. The power of motion action can be achieved by hydraulic, electrical or mechanical type action imposed on the device. In the proper configuration, all of the power of motion described can be introduced to the unit thus causing it to function. This view also shows both the hydraulic cylinder style of power of motion and the cable winch configuration. The cable winch, can be powered by all power of motions previously described. The magnitude of performance of this mechanical system can be altered by installing heavier or lighter and higher or lower performing components to meet the functionality the user requires.

In the hydraulic cylinder (14) mode, the moving end of the hydraulic cylinder (19) is connected to the adjustable lift pivot point mechanism (13) and it is attached to the rotary action bar (06). When the cylinder is activated the rotary action bar (06) is turned. There are adjustment slots on the adjustable lift pivot point mechanism (13) to allow for different levels of lifting ability by the mechanical lifting mechanism (08). The lifting arms (09),(10),(11) are detachable and are normally affixed to the mechanical lifting device cross member (02), in an attachment point(s) (05), using a pin (12). Whenever pin (12) is shown in any drawing, it refers to a metal rod type pin that can be a pin with threaded and bolted configuration, or threaded and bolted on one end and smooth cylinder on the other to receive components, with snap ring or keeper type slot on the end for locking attached component in place.

Within the broad range of functionalities of the device embodying the present invention. For example, the pin (12) could also be a bolt with nuts or solid metal rod, all made and designed to allow proper attachment of component parts.

### III. Additional Support Mechanism 8 Trailer Hitch Attachment

The portable mechanical lifting and lowering device (01) can operate without any additional support, however, the total gross weight lifting ability of the device is limited by the maximum gross weight capacity of the vehicle's trailer hitch receiver port. With the addition of a support mechanism to help distribute the weight, the gross weight capacity of the portable mechanical lifting and lowering device can far exceed that of the vehicle's trailer hitch receiver port's maximum weight allowance.

One of the ways in which additional support can be introduced is to add axles (21) and wheels (20) to the adjustable pivot support arm (22) that is connected to the rotary action bar (06). When the power of motion is applied, the rotary action bar (06) is rotated, thus, rotating the wheels in a radius arc fashion downward and toward the load to be lifted, therefore introducing additional weight support for the mechanical lifting and lowering device. Wheels (20) can be adjusted for proper positioning under load conditions and they allow for the vehicle to move easily when a load is applied, while not exceeding the maximum gross weight requirement of the trailer hitch receiver port of the vehicle. Although the wheels can easily travel with the vehicle, the user must stay within the wheel load and speed allowances. The drawing depicts stationary typed fixed axles on the adjustable pivot support arm (22), however, torsion style, or suspension style axle(s) could be utilized in the configuration to allow for better over the road performance with the vehicle in motion and under load. Wheel(s) (20) of varying types can be used depending on the user's application. In place of wheel(s) (20), other types of support structures could be used, such as, but not limited to, skid plates, runners, rollers and other mechanisms that would still allow for some movement by the vehicle while the device was under load.

The trailer hitch ball attachment (23) shown in the drawing of the device, shows an attachment of this trailer hitch attachment to the mechanical lifting mechanism (08), with a trailer hitch ball (24) attached to it. This enables the device to easily lift any type of trailer or device that would utilize a trailer hitch ball receiver for its connection point. This is essential for applications where trailers are needed to be moved or transported easily. For example, a trailer manufacturer or trailer sales operation, could easily use this device to move trailers around the lot/property by simply backing up the host vehicle to the trailer hitch ball receiver port and engaging the power of motion on the mechanical lifting and lowering device, thus lifting the tongue of the trailer so that it can be easily transported to any location. In a marine operation of manufacturing, repairing, detailing, storing, selling or renting boats, the user could easily move the boats on trailers to any location on the lot using the mechanical lifting and lowering device's trailer hitch ball attachment (23). Currently a farm style tractor with a three point hitch type mechanism is used or other apparatuses that are not as convenient as this invention. Aircraft at an airport could be moved in the same manner with devices that already exist which have a trailer hitch ball receiver port on one end and an aircraft attachment device on the other. With a front mounted trailer hitch receiver port on the vehicle, the user could utilize the portable mechanical lifting and lowering device in the front of his vehicle instead of the rear, for better control of movement of the load being moved. This would be very beneficial in moving aircraft and boats. The three point hitch style lifting arms (09),(10),(11) can be removed for more ease of use of the trailer hitch ball apparatus.

### IV. Anti-Sway Mechanism

FIG. 1 depicts a simple attachment of an anti-sway mechanism (26), connected between the lifting arm (10) and the connection point (05) on main cross structure (02). In this drawing it is shown as a chain connected, but can be made up of several different mechanisms with fixed or adjustable sections to enable the user to easily make an adjustment. This anti-sway mechanism (26) is normally a dual system and would be located on each side of the main cross structure (02) and attached to both lifting arms (09), (10). This mechanism's purpose is to allow for easy hook up of the lifting arms to a three point hitch style implement by allowing the lifting arms (09),(10) to move outwardly to accept the implement hitch points within the range of attachment, and then to allow the lifting arms (09),(10) to swing inwardly and connect to the implement hitch points. Once connected, the anti sway mechanism (26) is to be tightened, or shortened, to a length that will hold the implement firmly into a centered position on the portable mechanical lifting and lowering device (01),(02),(03). When tightened, the anti-sway mechanism (26) still allows for movement of the lifting arms (09),(10) in an up and down fashion to enable the user to operate the implement properly. A properly positioned and fixed in place implement is essential when the device is pulling an object like a scraper type blade, due to the fact that with the blade angled off of perpendicular to the direction it is being pulled, the physical movement of the material being scraped at an angle tends to force the scraper blade to want to move to the opposing side of the portable mechanical lifting and lowering device (01),(02),(03), the anti-sway mechanism (26) prevents the scraper blade from moving in that direction, as it should remain fixed or stationary in its position relative to the vehicle host, so that it will perform its function properly. Proper use of the anti-sway mechanism (26) provides for proper function of the portable mechanical lifting and lowering device (01),(02),(03).

### V. Jack (Drop) Stand Mechanism 28,27

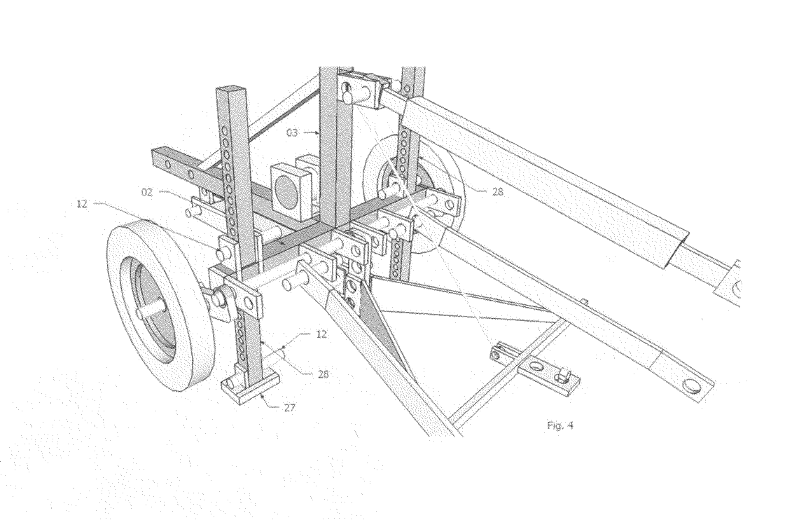

FIG. 4 depicts a jack (drop) stand mechanism (28) with base plate (27) attachment. Jack (drop) stand mechanisms are shown on both sides of the portable mechanical lifting and lowering device (01),(02),(03) to provide ample balanced support for any load to be lifted. The jack (drop) stand mechanism (28) can be moved up and down and has multiple holes for proper fixed adjustment by a pin (12) of the support needed by the user. If the portable mechanical lifting and lowering device (01) is on uneven ground, the jack (drop) stand mechanisms (28) can be adjusted to the proper length to allow for adequate support. The drawing depicts the jack drop stand mechanism (28) sliding through and opening on the main cross structure (02), however, it can be mounted to the side, edge or end of the main cross structure (02) and provide the same support. When properly attached to the host vehicle, the portable mechanical lifting and lowering device (01),(02),(03) only requires additional support when the load to be lifted exceeds the trailer hitch receiver port weight capacity. The jack (drop) stand mechanisms (28) can be used with or without the wheeled additional support mechanisms. A single or an additional jack (drop) stand mechanism (28) can be located near or inside the vertical main structure (03) of the portable mechanical lifting and lowering device (01). These jack (drop) stand mechanisms (28) can be used for any lifting or lowering requirement the user has and provides additional structural balance and support and helps to stabilize the load. The base plate (27) is shown attached by a pin (12) to the bottom of the jack (drop) stand mechanisms (28). In normal, stationary support applications, this base plate (27) will work adequately. However, this type of attachment does not allow for any movement of the host vehicle, thus, the base plate (27) can be removed and replaced with attachments for wheels, rollers, runners, larger skid plates and other devices as required by the user, including but not limited to a single axle or dual axle assembly for a fixed aspect wheeled trailer action by the device. The jack (drop) stand mechanisms (28) are normally lifted and affixed for transport.

### VI. Crane Mechanism 29,30,31

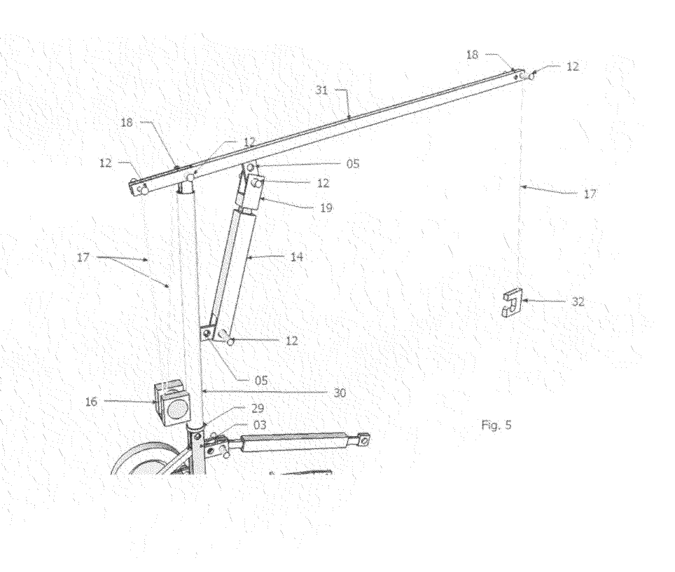

FIG. 5 depicts the portable mechanical lifting and lowering device (01),(02),(03) shown with its center mount crane mechanism (29),(30),(31) located in and attached to the vertical main structure (03). The crane mechanism is designed for ease of use by the operator, utilizing the same power of motion devices used by the portable mechanical lifting and lowering device (01),(02),(03), including but not limited to hydraulic, pneumatic, electrical, or mechanical means of power. The crane mast (30) assembly sits atop a crane spindle mechanism (29), which allows the crane mast (30) to turn in a 360 degree range. The spindle mechanism (29) affixes itself to the vertical main structure (03). The crane beam (31) attaches to the top of the crane mast (30) and is affixed by pin (12) at a position that can be selected by the user and relative to the load to be lifted. The crane beam (31) can be supplied with multiple hole attachment points that can allow for increased or decreased load capability of the device. By lever action at the fulcrum point pin (12) at the top of crane mast (30), crane beam (31) can be made to lift larger or smaller loads at shorter or longer radius lengths from the center point of the crane mast (30). The crane mast (30) can also be adapted with adjustment points that can raise or lower the height of the crane mast (30), altering the lifting and lowering capability of the device. The drawing shows two potential power of motion devices that can operate the crane mechanism (29),(30),(31). The hydraulic cylinder (14),(19) can be attached to attachment points (05) on the crane mast (30) and the crane beam (31) to operate a lifting and lowering motion of the device. Multiple attachment points (05), including opposite sides for inverted action and other adaptations can be added to the crane mast (30) and the crane beam (31) to allow for multiple adjustments for proper weight capacity lifting or lowering and for varying sizes of cylinders that may increase or decrease the power capacity and overall movement of the device. The cable winch (16),(17) power mechanism is shown mounted to the crane mast (30). Cable winch (16) cable (17) is shown in two configurations, first being that of the winch cable (17), running to pulley (18) atop crane mast (30), and then to the load end of crane beam (31) to another pulley (18) and then dropping vertically to cable hook (32). In this configuration, the cable winch (16) can lift or lower a load vertically from the end of crane beam (31), while turning in a 360 degree motion. The second configuration shows cable winch (16) cable (17) connecting to the non load lifting end of the crane beam (31) by means of pin (12). In this configuration the cable winch (16) can operate the crane beam (31) up and down in a lever fashion by extracting or retracting cable (17) from cable winch (16) and this action cause's crane beam (31) to pivot on pin (12) at the top of crane mast (30), raising or lowering the load end of crane beam (31). The cable winch (16) and cable (17) can be operated from the portable mechanical lifting and lowering device (01),(02),(03) on any of it's structures, however, care must be taken to ensure that there is no cable (17) obstruction in the path of the cable (17) for the task to be performed. The cable winch (16) and cable (17) can be operated from various locations atop the crane beam (31) to lift and lower loads through direct connection or through a pulley (18) mechanism. Crane beam (31) can be adapted to ad counter weight loads to offset the load to be lifted. Pulley(s) (18) are normally used in the powered cable (17) actuation method, except where it may be directly attached to a load or attachment point (05) without any mechanical need for a pulley.

### VII. Crane Adapters 33,34

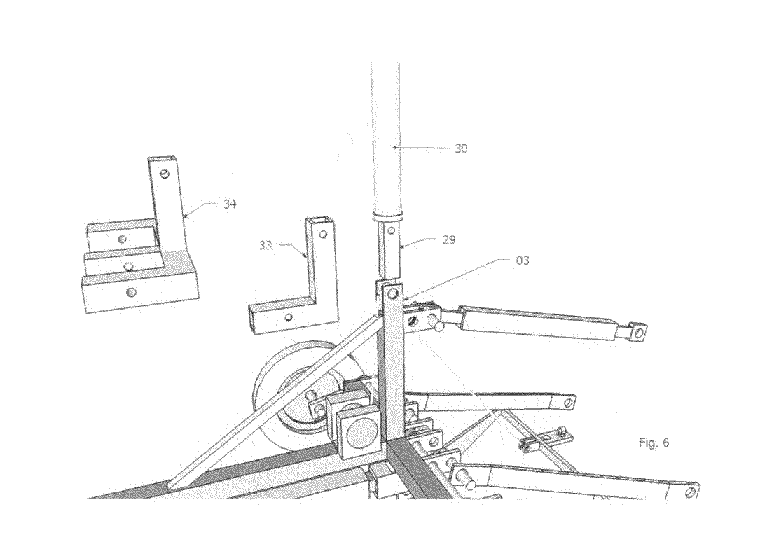

FIG. 6 depicts a more detailed drawing of the crane spindle (29) and its attachment to the crane mast (30) and how it attaches to the vertical main structure (03). A pin (12), not shown, would be used to affix the crane spindle (29) to the vertical main structure (03). As the crane mast (30) and crane spindle (29) are removable, they could be attached to crane single vehicle adapter (33) or crane multiple armed vehicle adapter (34). The vertical end shown of both adapters would accept crane spindle (29) and the horizontal end of the adapters can be directly mounted to the host vehicle trailer hitch receiver port. This would enable the crane mechanism (29),(30),(31) to be used without the need for the portable mechanical lifting and lowering device (01),(02),(03). In this adaptation, the crane mechanism (29),(30),(31) still requires power to be operated, either supplied from an outside source or by hand (by the operator) or by a self contained power device that may be mounted to the host vehicle or the crane mast (30), (31) assembly. A self contained power device could be mounted at the no load end of the crane beam (31) and even act as a counter weight to the load being lifted. Location of any counter weight on the crane beam (31) will affect the load capability of the device. Adaptations of the crane single vehicle adapter (33) or crane multiple armed vehicle adapter (34) would allow for connection and use of jack (drop) stand(s) (28),(27), or other attachment to provide additional weight support for lifting the load or for movement of the vehicle.

### VIII. Multiple Trailer Hitch Receiver Port Attachment 35,36

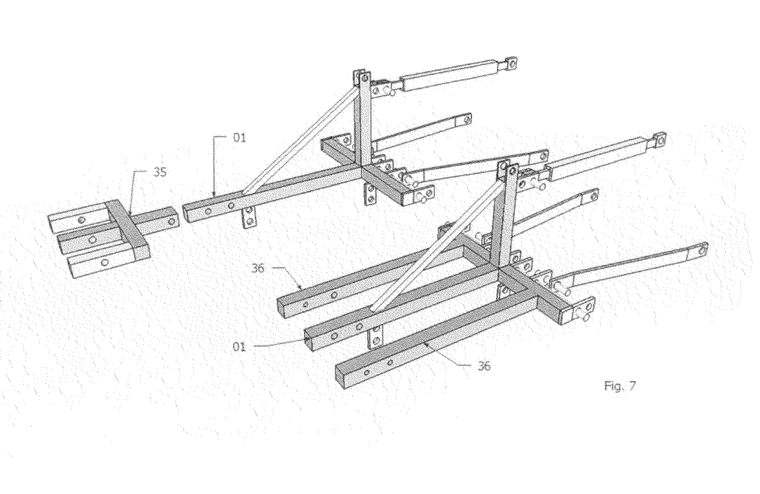

FIG. 7 depicts the portable mechanical lifting and lowering device (01),(02),(03), with various configurations of attachment methods to a host vehicle. The first adaptation shows an attachment for a ganged receiver port attachment adapter (35), that could be mounted to a standard single armed portable mechanical lifting and lowering device (01),(02),(03) and then mounted to a multiple ported trailer hitch receiver on a host vehicle. The second adaptation shows a portable mechanical lifting and lowering device (01),(02),(03), with multiple attachment arms (36) for connection to a host vehicle's multiple port trailer hitch receiver or to a stationary application, with or without the use of adapters.

### IIX. Insertion & Extraction Mechanism 37,38,43

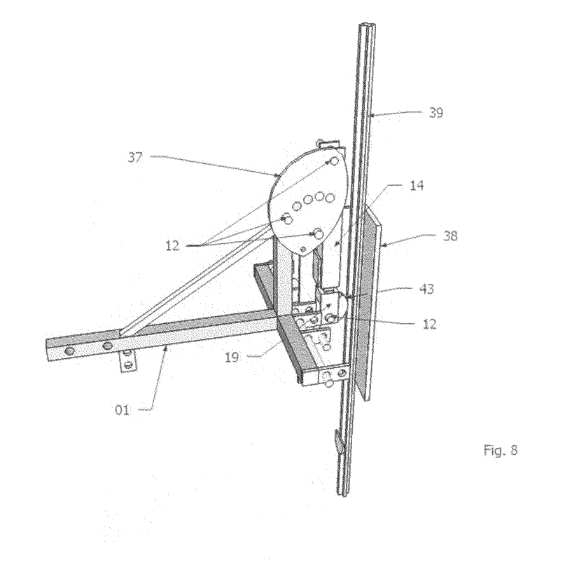

FIG. 8 depicts the portable mechanical lifting and lowering device (01),(02),(03), with an extraction and insertion base mechanism (38),(37),(14),(19),(43), mounted to it. This device enables the user to insert or extract rods, fence posts, sign post, flagged markers, property markers into the earth or other surface. A steel post (39) for a fence is shown in the drawing. Other various items can be adapted for insertion or extraction by the device. In this drawing adaptation, a hydraulic cylinder (14) activates and moves action end of cylinder (19), forcing the lever action of the gripping mechanism (43) against the steel post (39) and then against the extraction and insertion base mechanism (38), forcing the steel post (39) to move. The drawing shows the device in its straight vertical mode. An angle adjustment mechanism (37) can be swiveled and locked in place with pin (12). As example: This ability enables the device to be adjusted to multiple angles so that when operated in uneven terrain, the device will provide a vertically straight inserted post, rod, sign, etc. With this invention, any standard pickup truck vehicle with the proper setup could easily be used to install road side mile markers, sign post, and other type roadside markers for bridges, culverts, snow depth, etc. Any farmer or rancher installing fencing, can now easily install fence posts quickly and easily using this device mounted to their vehicle. The extraction and insertion base mechanism (38) can be adapted for rollers to be implemented into the back side of the base, as example, where the gripping mechanism (43) forces lever action pressure against the post or rod to be moved and it would normally slide against the back plate base of the extraction and insertion base mechanism (38). Rollers would allow for ease of movement of any item being moved inside the unit, while still having pressure applied to it by the gripping mechanism (43) and the action of the hydraulic cylinder (14),(19). Other gripping mechanisms (43) are available, with forked or toothed apparatuses, that enable the user to install street signs, stop signs, and other rods, channels, or beams, that have multiple holes along their length. The holes, or teeth in some cases, allow for an adapter that can be directly connected to the item and the full force of the hydraulic cylinder (14), (19) can be applied.

### IX. Angled Depiction of Turning & Twisting Insertion & Extraction 41,42

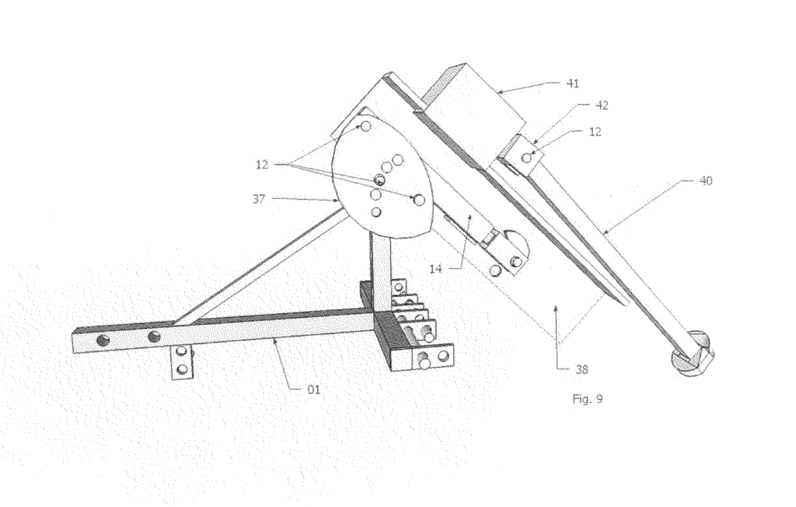

FIG. 9 is a perspective view of the portable mechanical lifting and lowering device (01),(02),(03) with the extraction and insertion base mechanism (38),(37),(14),(19),(43), mounted in place and shown at a parallel angle to the host vehicle, with a mechanical turning mechanism (41),(42) atop the extraction and insertion base mechanism (38). Rotary adjustment mechanism (37) is shown in a angled position. This rotary adjustable mechanism (37) can be adapted to be larger or smaller for more precision adjustment or ease of use and slots instead of holes with bolts and nuts could be used to affix the mechanism in place, it can also be moved from the location shown and attached in a different style of configuration that may mount differently on the device, while still performing its angular adjustment capabilities. The mechanical turning mechanism (41),(42) is designed with guides to mount on top of the extraction and insertion base mechanism (38). Since the most notable function of this device is to twist earth type tie down rods into or out of the ground, an allowance for the thread design of the tie down rod (40) must be allowed as some will be coarser or finer screw type threaded. To account for this, the device has been designed to allow for the mechanical turning mechanism (41),(42) to be able to slide up and down, without restraint, on the extraction and insertion base mechanism. Fixed or adjustable stops would be placed at either end of the device to keep the mechanical turning mechanism from falling off the extraction and insertion base mechanism (38). This fluid of motion ability enables the device to turn the threaded tie down rod (40) at a nominal rate and as example, the tie down rod would screw itself into the earth at its own pace and the mechanical turning mechanism will move with the tie down rod at the pace of its own insertion. An adaptation for the mechanical turning mechanism (41),(42) is an attachment to the mechanical guide of the mechanism to enable it to be connected to the hydraulic cylinder (14),(19), therefore being able to apply force for insertion or extraction as may be required by the application or user preference. This type of function would be beneficial in applications for drilling holes for explosives in mining where rotary action and applied force helps to drill holes in the earth or surfaces, ultimately leaving a hole for the placement of explosives to help in the extraction of the material. The same type of configuration could also be applied when using a larger auger bit on the device to drill a hole in the ground for a corner fence post or sign style post. With this invention, a standard auger for a post hole digger could be adapted to be used with this device to drill holes in the ground for piers, fence post holes, water meter style holes for pipe an meter installation, telephone or light poles, and many other applications requiring this type of capability.

### X. Three Dimensional Angled Depiction of Extraction and Insertion Base Mechanism 44

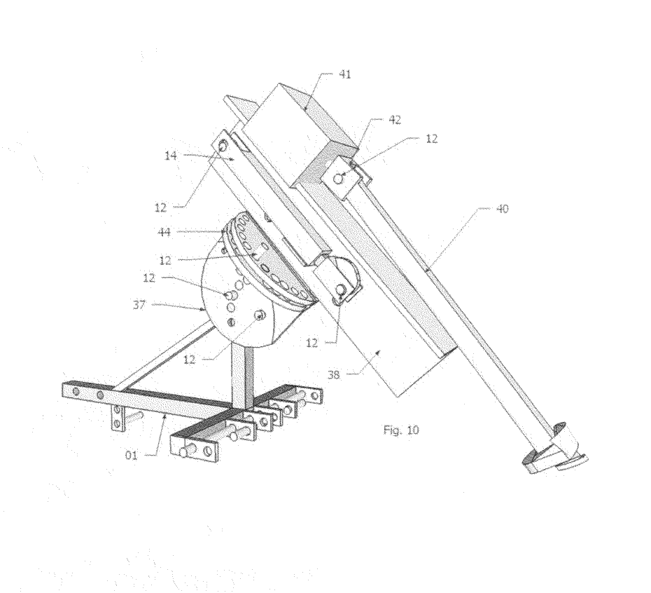

FIG. 10 depicts the three dimensional operational version of the extraction and insertion base mechanism (38),(14),(19),(43), mounted on the rotary adjustment disk (44) apparatus and then mounted to the rotary adjustment mechanism (37). In this configuration, the extraction and insertion base mechanism (38),(37),(14),(19),(43) can be angled in two different rotary planes at the same time, giving it a three dimensional ability to extract and insert items as has been previously described. The adjustment disk (44) apparatus moves the device in the perpendicular plane to the host vehicle and the adjustment mechanism (37) moves the device in a parallel fashion to the host vehicle. Other versions of the rotary adjustable disk (44) and rotary adjustment mechanism (37), can be configured to mount to the rotary action bar at one end of the main cross structure (02), giving it the rotary motion needed for angular insertion. As example: A bar or pipe can be inserted into the mechanical lifting and lowering device's (01),(02),(03), main attachment structure arm (01) with an adaptation for adjustment control, and then the fixed connection to another adjustable rotary disk type device, similar to the rotary adjustment mechanism (37), to create basically the same results in a smaller and easier to use version as compared to what is depicted here. This larger style drawing is shown for clarity and understanding. The extraction and insertion base mechanism (38),(14),(19), with the mechanical turning mechanism (41),(42), is shown atop and mounted to the rotary adjustment disk (44), affixed appropriately with pin(s) (12).

### XI. Variations and Adaptations

It is to be understood that the invention can be embodied in various forms, and is not limited to the examples discussed above. Other components and configurations can be utilized in the practice of the present invention.

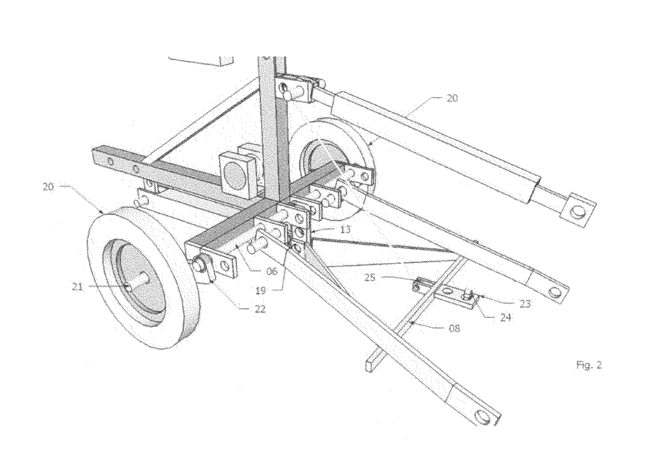

The trailer hitch ball attachment (23) in FIG. 2 can be reconfigured to have the mechanical lifting mechanism (08) removed from adjustable lift pivot point mechanism (13) and replaced with a straight tube or structure, as example, similar to the tubing used in the portable mechanical lifting and lowering device (01), attached to the adjustable lift pivot point mechanism (13) and made to be moved up and down with a standard type trailer hitch ball mounted on the opposite end of the tube. The power of motion could be supplied by the hydraulic cylinder (14),(19) or the cable winch (16) and cable (17) with proper attachment to an attachment point on the tube near the opposite end. The lifting arms (09),(10),(11) could be removed allowing for ease of use by the operator to just operate the trailer hitch ball (23) for moving trailers and other such equipment. The use of a straight tube instead of the mechanical lifting mechanism (08) in its drawn form, would be easier to use and less cumbersome for the operator. The width and style of design of the mechanical lifting mechanism (08) cross bar may interfere with the trailer tongue to be moved during turning of a trailer under transport. This adaptation of the trailer hitch ball attachment (23) can be reduced to its simplest form, whereby the portable mechanical lifting and lowering device (01),(02),(03), can have its main cross structure (02), and vertical main structure (03) removed, leaving just the main attachment structure arm (01) with its power of motion functions still in place and the attachment of the straight tube trailer hitch ball attachment as previously described. This style of mechanism would be most adaptable to all operations that required the ability to easily move and transport trailers or other items that have a similar trailer ball hitch attachment.

The portable mechanical lifting and lowering device (01),(02),(03) can be adapted to a trailer mode of operation, whereby wheels are affixed to the device as shown in the drawings or as previously described and a trailer ball hitch attachment affixed to the main attachment structure arm (01) of the device so that it is transformed into a trailer and can be easily pulled behind a vehicle.

The adjustable lifting arm (11) can be moved downward into the same rotating plane as the lifting arms (09), (10), and with the proper adjustment of the length the adjustable lifting arm (11), a three point attachment to a level lifting platform can be used to lift items in a level plane throughout its normal operating motion. This level lifting function, as example, can be very useful when raising or lowering an item to the height of the vehicle bed.

Having thus described the invention, what is claimed as new and desired to be secured by Letters Patent:

1. A portable mechanical lifting and lowering device for mounting to a host vehicle, trailer, or other mode of transportation, normally through its trailer hitch style receiver port, or to a stationary device, enabling the user to easily lift, lower, move and even operate items, including equipment, trailers and farm type implements.

2. The portable mechanical lifting and lowering device according to claim 1, which includes: a movable mechanism that includes a lifting arm configuration that mimics the three point hitch lifting ability and implement attachment of a standard farm tractor, including dual lifting arms, an adjustable length top arm and adjustable anti-sway linkage to minimize lifting arm movement and reduce any sway of the device being lifted or lowered. The size of the mechanism can be altered to accommodate the size and weight of the load to be lifted. The mechanism can be powered by lever action, hand winch, electrical or hydraulic winch, or hydraulic (oil) or pneumatic (compressed air) powered cylinder action or a combination thereof. This mechanism can also include a fixed or adjustable length arm that can be connected at both ends to attachment points on the device to hold the lifting mechanism in a specific position. This function will help to remove the weight load from the power of motion device and serve to hold the load in a fixed position for transport or for long term storage in that position.

3. The portable mechanical lifting and lowering device according to claim 1, which includes: multiple attachments and adaptations to accommodate the proper lifting or lowering of the item in question, including but not limited to a trailer hitch ball attachment, and other type attachments for moving specific items or objects.

4. The portable mechanical lifting and lowering device according to claim 1, which includes: an adaptation for one or more of the following items that can be used to provide the power of motion for the portable mechanical lifting and lowering device mechanism, including hydraulic or pneumatic (oil or air) cylinder or motor, or linear actuator, or electric motor, or cable winch, or hand operation, or a combination thereof. The portable mechanical lifting and lowering device can be adapted to include on and off type switches, valve(s) control or regulator type control mechanism(s) to allow for ease of use of the device and precision control of the device by the user. The power to for these systems can be introduced separately from an outside source, or supplied by a complete self contained on board system which may include one or more of the following; DC battery supply, a AC generator, a compressed air tank, an air compressor, a hydraulic pump, a gasoline or diesel engine, all of which can be adapted and combined as necessary to provide the power of motion to operate the device.

5. The portable mechanical lifting and lowering device according to claim 1, which includes: an adaptation for a powered extraction and insertion mechanism to lift or lower posts, stakes, poles, rods, pipes, bars, or other items that would be inserted into the earth or other subsurface, or removed from the earth or other subsurface as required by the user. The device can be adjusted for vertical, angled, or horizontal positioning of the item to be moved, inserted or extracted.

6. The portable mechanical lifting and lowering device according to claim 1, which includes: an adaptation for a powered device that enables the process of lifting or lowering an item as previously described with a twisting or turning fashion, as it is being moved.

7. The portable mechanical lifting and lowering device according to claim 1, which includes: an adaptation for a crane style lifting and lowering mechanism that can be attached to the portable mechanical lifting and lowering device for lifting and lowering items and moving them in vertical (up and down) and horizontal 360 degree (spiral/radius) directions. Use of hydraulic cylinders along with the use of a winch cable mechanism can allow for full movement of the crane beam in the vertical and horizontal directions, but also via a vertical movement at the end of the crane beam lifting the load by means of a controllable cable winch.

8. The portable mechanical lifting and lowering device according to claim 1, which includes: an adaptation for a hydraulic cylinder, or cable winch apparatus, that can be used to move/turn the rotary action rod and thus move the mechanical lifting mechanism through a movement of a lifting and lowering cycle. The hydraulic cylinder can be removed from its lowest position located under the main support tube and adapted along the vertical support tube and can be adapted; to move the main support rotary action rod; or to move the top attachment arm of the three point hitch lifting configuration; or adapted to move a lever arm that in turns, lifts one or both of the lower three point hitch lifting arms of the mechanical lifting and lowering device.

9. The portable mechanical lifting and lowering device according to claim 1, which includes: an adaptation for a cable type winch to be used for the power of motion for the mechanism, connected directly or through a pulley system to actuate the capabilities of the device. The cable winch can be powered by hand operation, electrical motor, hydraulic motor, or other means and the pulley system can be single wrap configuration or in a block and tackle style manner and can be mounted in various locations to provide the power of motion as required.

10. The portable mechanical lifting and lowering device according to claim 1, which includes: a support mechanism to provide additional weight distribution support to the portable mechanical lifting and lowering device. This support can be supplied by static or movable wheels, jack style stands, jacks, swivel jack with hand crank, linear actuators, runners, skids, or other means of support. The wheels or other means of support, (skid plate, runners, etc.) can be operated into position by the movement of the power lift motion of the device and the turning of the rotary action rod, to provide support when the load is supplied to the device. The mechanism can be adapted to automatically allow the support to be introduced as the unit is operated or load is applied, or the support can be introduced and then made stationary, while the lifting operation of the load or tool takes place separately. Proper additional support mechanisms must be used to accommodate any movement of the vehicle or for any stationary support used, during the lifting action of the load.

11. The portable mechanical lifting and lowering device according to claim 1, which includes: additional support by means of wheels, skids, runners, stands, or jacks to enable the portable mechanical lifting and lowering device to lift or lower more than the maximum operation weight capacity of the trailer hitch receiver port or other means of attachment to the vehicle or if used in a stationary mounting location. With the mechanical lifting and lowering device's own support mechanism in place, the portable mechanical lifting and lowering device can now be used to lift loads greater than the maximum weight capacity of the trailer hitch receiver port.

12. The portable mechanical lifting and lowering device according to claim 1, which includes: an assortment of adjustment holes and slots throughout the device's mechanisms to allow for several levels of adjustment and settings of the mechanical lifting and lowering devices abilities and capabilities and adaptations to the needs as required by the user. Interchangeable wheels, skids, jacks, and other supports, as well as connection points for varying means of adaptation to the power source supplying the power to all of the lifting mechanism capabilities is possible.

13. The portable mechanical lifting and lowering device according to claim 1, which includes: the ability to be mounted at the rear or front of the host vehicle or in any location where there is trailer hitch style receiver or multiple receivers or other means of attachment adequate enough to support the portable mechanical lifting and lowering device and its load.

14. The portable mechanical lifting and lowering device according to claim 1, which includes: a trailer hitch adapter of multiple attachment arms for the receiver device, which has multiple receivers that can be mounted to the host vehicle and attached to the portable mechanical lifting and lowering device. This includes the attachment of multiple arms from the portable mechanical lifting and lowering device to the multiple trailer hitch style receiver. The number of attachments to the receiver can be increased or decreased as necessary to accommodate load.
